(19) United States
(12) Patent Application Publication
(10) Pub. No.: US 2015/0042585 A1
(43) Pub. Date: Feb. 12, 2015

(54) SYSTEM AND ELECTRONIC DEVICE OF TRANSIENTLY SWITCHING OPERATIONAL STATUS OF TOUCH PANEL

(71) Applicant: Sentelic Corporation, Taipei City (TW)

(72) Inventor: Jao-Ching Lin, Taipei City (TW)

(21) Appl. No.: 14/452,501

(22) Filed: Aug. 5, 2014

(30) Foreign Application Priority Data
Aug. 6, 2013 (TW) 102214716

(51) Int. Cl. G06F 3/041

(52) U.S. Cl. CPC G06F 3/041; G06F 2203/04104
USPC 345/173

(57) ABSTRACT

When a touch panel operating in a first status detects a first trigger signal, the touch panel is configured to switch to a second status. When the touch panel detects a second trigger signal before a predetermined period has elapsed after receiving the first trigger signal, or when the touch panel does not detect the second trigger signal after the predetermined period has elapsed after receiving the first trigger signal, the touch panel is configured to switch back to the first status.

### BACKGROUND OF THE INVENTION

1. Field of the Invention

The present invention is related to systems of controlling operational modes and related electronic devices, and more particularly, to systems of transiently switching operational modes and related electronic devices.

2. Description of the Prior Art

Touch panels are characterized in easy control, fast response and thin appearance and have been widely used in various electronic devices, such as tablet computers, personal digital assistants (PDAs), satellite navigation systems and media players.

A touch panel may operate in different modes for simulating different physical devices. Taking a tablet computer as an example, a user may choose any of the applications displayed on the touch panel, such as an editing application or a computing/statistics application. The user may then input data to edit or to calculate. As the electronic devices are miniaturized, the screen size becomes insufficient for displaying all input options at the same time. A conventional touch panel is configured to operate in an editing mode for inputting characters and operate in a numeric mode for inputting numbers. Therefore, it is very inconvenient for users to switch among different operating modes manually.

### SUMMARY OF THE INVENTION

The present invention provides a system of transiently switching operational modes. The system includes a touch module configured to operate in a normal mode and at least one transient mode, and output at least one first transient switch signal when receiving a first transient switch command from a user; and a control device electrically connected to the touch module and configured to switch the touch module to the at least one transient mode when detecting the at least one first transient switch signal so that the touch module operates in the at least one transient mode during a predetermined period; and switch the touch module to the normal mode when detecting a second transient switch command after detecting the at least one first transient switch signal or when the predetermined period has elapsed after detecting the at least one first transient switch signal.

The present invention also provides an electronic device of transiently switching operational modes. The electronic device includes a touch module configured to operate in a normal mode and at least one transient mode, and output at least one first transient switch signal when receiving a first transient switch command from a user; a control device electrically connected to the touch module and configured to switch the touch module from the normal mode to the at least one transient mode when detecting the at least one first transient switch signal so that the touch module operates in the at least one transient mode during a predetermined period; and switch the touch module from the at least one transient mode to the normal mode when detecting a second transient switch command after detecting the at least one first transient switch signal or when the predetermined period has elapsed after detecting the at least one first transient switch signal; and a physical keyboard arranged to generate the second transient switch command or the second transient switch command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a system capable of transiently switching operational modes according to an embodiment of the present invention.

FIGS. 2˜5 are diagrams illustrating the operations of the system when transiently switching operational modes according to embodiments of the present invention.

### DETAILED DESCRIPTION

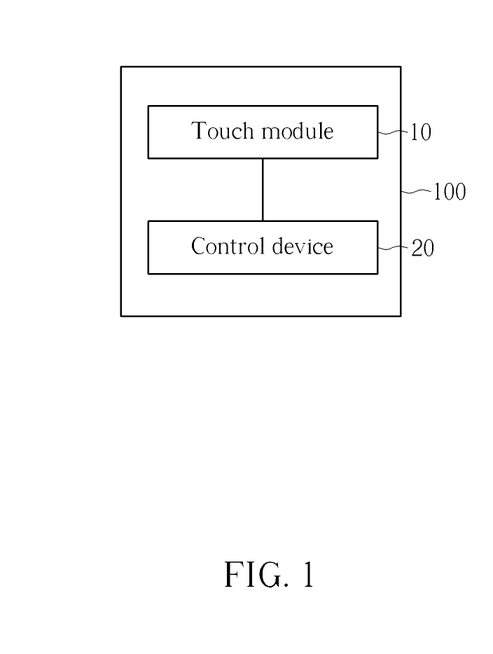

FIG. 1 is a functional block diagram illustrating a system 100 capable of transiently switching operational modes according to an embodiment of the present invention. The system 100 includes a touch module 10 and a control device 20. The touch module 10 is configured to operate in a normal mode and multiple transient modes, and to output a corresponding transient switch signal when receiving a transient switch command from a user. The control device 20 is electrically connected to the touch module 10, and configured to receive transient switch signals and to switch the touch module 10 to a specific transient mode, so that the touch module 10 operates in the specific transient mode during a predetermined period.

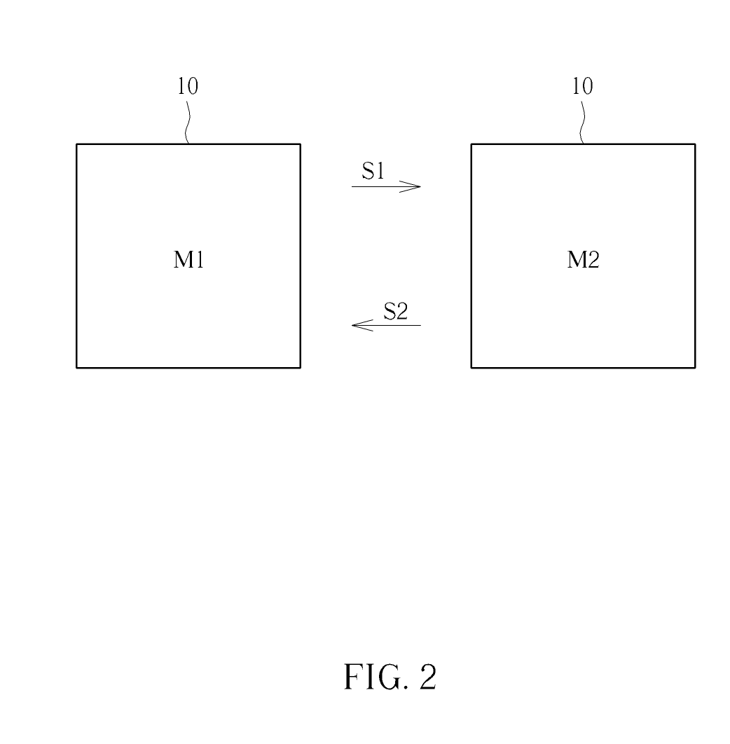

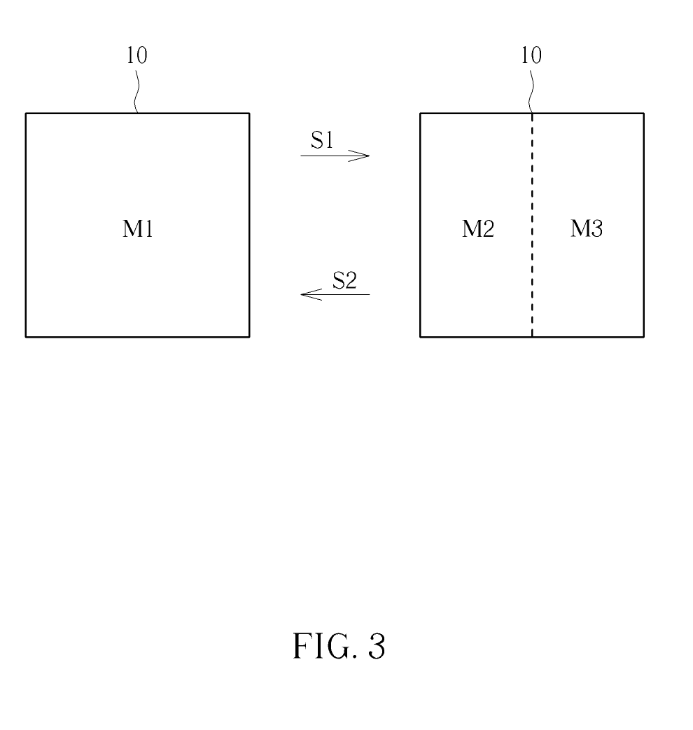

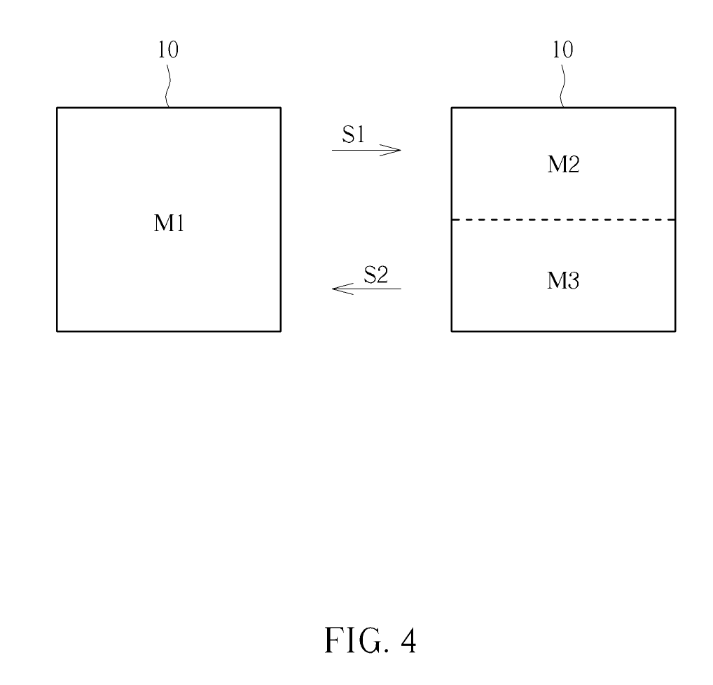

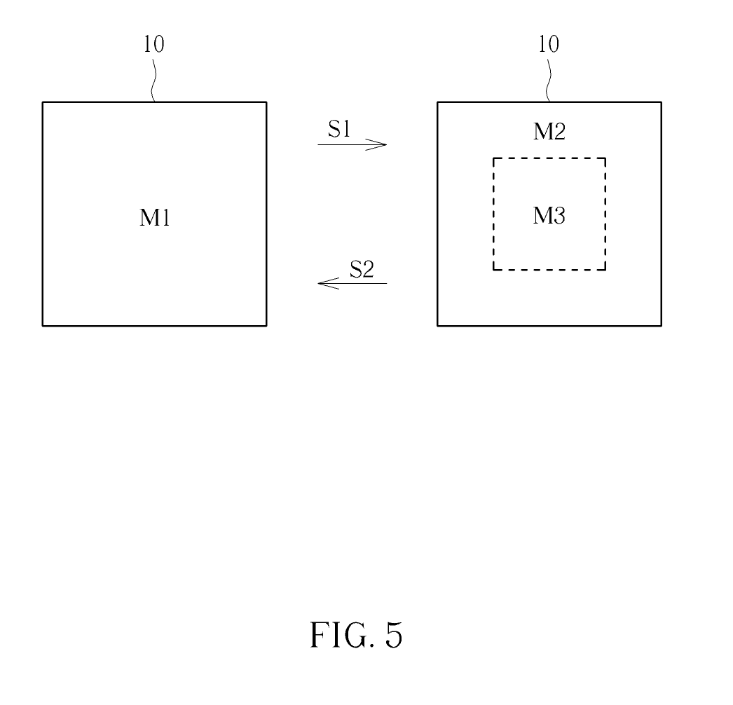

FIGS. 2-5 are diagrams illustrating the operations of the system 100 when transiently switching operational modes according to embodiments of the present invention. At first, the touch module 10 is configured to operate in the normal mode. As illustrated in step S1, when a first transient switch command is detected, the touch module 10 switches from the normal mode to the transient mode. As illustrated in step S2, the touch module 10 switches back to the normal mode when a second transient switch command is detected before a predetermined time period elapses after the first transient switch signal has been detected, or when the predetermined time period elapses after the first transient switch signal has been detected without detecting the second transient switch command.

In the embodiment illustrated in FIG. 2, when the touch module 10 operates in the normal mode, an effective sensing region of the touch module 10 operates in a first mode M1. When the touch module 10 operates in the transient mode, the effective sensing region of the touch module 10 operates in a second mode M2.

In the embodiments illustrated in FIGS. 3-5, when the touch module 10 operates in the normal mode, a first sensing region operates in the first mode M1. When the touch module 10 operates in the transient mode, a second sensing region of the touch module 10 operates in a second mode M2, and a third sensing region of the touch module 10 operates in a third mode M3. The sum of an area of the second sensing region and an area of the third sensing region does not exceed an area of the first sensing region. For example, the first sensing region may be the total effective sensing region of the touch module 10, while the second and the third sensing regions may be the left half and the right half of the effective sensing region of the touch module 10, respectively, as illustrated in FIG. 3, the upper half and the lower half of the effective sensing region of the touch module 10, respectively, as illustrated in FIG. 4, or some picture-in-picture sub areas within the effective sensing region of the touch module 10 as illustrated in FIG. 5.

In the embodiments of the present invention, the first mode M1 to the third mode M3 may be a touch key mode, a mouse mode, a joystick mode, a numeric keyboard mode, or a handwriting input mode, etc. In the touch key mode, the touch module 10 is configured to report back the location and pressure of the press of a finger or a stylus for simulating a specific physical key. In the mouse mode, the touch module 10 is configured to report back the difference of the relative locations of the touch points, and to move the cursor accordingly. In the joystick mode, the touch module 10 is configured to simulate a direction key of a joystick corresponding to an eight-point operation. In the numeric keyboard mode, the touch module 10 is configured to simulate a numeric physical keyboard corresponding to the operation of numerals 0 to 9 and operation keys. In the handwriting input mode, the touch module 10 is capable of detecting a moving path of a finger or stylus in order to recognize the alphabet or character input by handwriting. The second mode M2 and the third mode M3 may be different operation modes assigned by the user.

In the embodiments of the present invention, the first transient switch command and the second transient switch command may be issued by touching the same location of the touch module 10 in different ways. For example, the first transient switch command may be issued by continuously tapping M times on a specific location of the touch module 10, and the second transient switch command may be issued by continuously tapping N times on the specific location of the touch module 10, wherein M and N are different positive integers. For another example, the first transient switch command maybe issued by pressing on the specific location of the touch module 10 for M seconds, and the second transient switch command may be issued by pressing on the specific location of the touch module 10 for N seconds, wherein M and N are different positive integers.

According to the embodiments of the present invention, the first transient switch command and the second transient switch command may be issued by touching different locations of the touch module 10 in an identical way. For example, the first transient switch command may be issued by continuously tapping M times on a first location of the touch module 10 and the second transient switch command may be issued by continuously tapping M times on a second location of the touch module 10, wherein M is a positive integer and the first location is different from the second location. For another example, the first transient switch command may be issued by continuously pressing on a first location of the touch module for M seconds, and the second transient switch command may be issued by continuously pressing on a second location of the touch module for M seconds, wherein M is a positive integer and the first location is different from the second location.

According to the embodiments of the present invention, the first transient switch command and the second transient switch command may be issued by touching different locations of the touch module 10 in different ways. For example, the first transient switch command may be issued by continuously tapping M times on a first location of the touch module 10 and the second transient switch command may be issued by continuously tapping N times on a second location of the touch module 10, wherein M and N are different positive integers and the first location is different from the second location. For another example, the first transient switch command may be issued by continuously pressing on a first location of the touch module for M seconds, and the second transient switch command may be issued by continuously pressing on a second location of the touch module for N seconds, wherein M and N are different positive integers and the first location is different from the second location.

According to the embodiments of the present invention, the first transient switch command and the second transient switch command may be issued by giving different touch inputs within a same range of the touch module 10. For example, the first transient switch command may be issued by simultaneously generating M touch points within a specific range of the touch module 10, and the second transient switch command may be issued by simultaneously generating N touch points within the specific range of the touch module, wherein M and N are different positive integers. For another example, the first transient switch command may be issued by generating a first touch track within a specific range of the touch module 10, and the second transient switch command may be issued by generating a second touch track within the specific range of the touch module 10, wherein M and N are different positive integers and the first touch track is different from the second touch track. The first touch track and the second touch track may be any pattern formed by sliding a single finger, a single stylus or multiple fingers.

According to the embodiments of the present invention, the first transient switch command and the second transient switch command may be issued by giving the same touch input within different ranges of the touch module 10. For example, the first transient switch command may be issued by simultaneously generating M touch points within a first range of the touch module 10 and the second transient switch command may be issued by simultaneously generating M touch points within a second range of the touch module, wherein M is a positive integer and the first range is different from the second range. For another example, the first transient switch command may be issued by generating a specific touch track within a first range of the touch module 10, and the second transient switch command may be issued by generating the specific touch track within a second range of the touch module, wherein the first range is different from the second range and the touch track may be any pattern formed by sliding a single finger, a single stylus or multiple fingers.

According to the embodiments of the present invention, the first transient switch command and the second transient switch command may be issued by giving different touch inputs within different ranges of the touch module 10. For example, the first transient switch command may be issued by simultaneously generating M touch points within a first range of the touch module 10 and the second transient switch command may be issued by simultaneously generating N touch points within a second range of the touch module, wherein M and N are different positive integers and the first range of the touch module is different from the second range of the touch module. For another example, the first transient switch command may be issued by generating a first touch track within a first range of the touch module 10, and the second transient switch command may be issued by generating a second touch track within a second range of the touch module, wherein the first range is different from the second range, and the first touch track is different from the second touch track. The first touch track and the second touch track may be any pattern formed by sliding a single finger, a single stylus or multiple fingers.

The present invention maybe applied in a touch module of tablet computers, notebook computers, PDAs, mobile phones, satellite navigation systems and media players, wherein the touch module may include a touch panel. In the embodiments of the present invention, the first transient switch command and the second transient switch command may be generated by any physical keyboard of the electronic device.

The present invention provides a method and a system of transiently switching operation modes. When a transient switch command is detected, the touch module switches from a normal mode to a transient mode, and then switches back to the normal mode after a predetermined time automatically. The present invention also allows the user to manually issue the transient switch command to switch back to the normal mode. Therefore, the present invention provides fluent and convenient operation of the touch module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system of transiently switching operational modes, comprising:
a touch module configured to operate in a normal mode and at least one transient mode, and output at least one first transient switch signal when receiving a first transient switch command from a user; and
a control device electrically connected to the touch module and configured to:
switch the touch module to the at least one transient mode when detecting the at least one first transient switch signal so that the touch module operates in the at least one transient mode during a predetermined period; and
switch the touch module to the normal mode when detecting a second transient switch command after detecting the at least one first transient switch signal or when the predetermined period has elapsed after detecting the at least one first transient switch signal.

2. The system of claim 1, wherein:
the touch module operating in the normal mode includes an effective sensing region of the touch module operating in a first mode;
the touch module operating in the at least one transient mode includes the effective sensing region operating in a second mode; and
the first mode is different from the second mode.

3. The system of claim 1, wherein:
the touch module operating in the normal mode includes a first sensing region of the touch module operating in a first mode;
the touch module operating in the at least one transient mode includes a second sensing region of the touch module operating in a second mode and a third sensing region of the touch module operating in a third mode;
the second mode is different from the third mode; and
a sum of an area of the second sensing region and an area of the third sensing region does not exceed an area of the first sensing region.

4. The system of claim 1, wherein:
the first transient switch command is issued by continuously tapping M times on a first location of the touch module;
the second transient switch command is issued by continuously tapping N times on a second location of the touch module; and
M and N are positive integers.

5. The system of claim 4, wherein:
the first location is different from the second location; and
M is equal to N.

6. The system of claim 4, wherein:
the first location and the second location are at a same location; and
M is different from N.

7. The system of claim 1, wherein:
the first transient switch command is issued by pressing on a first location of the touch module for M seconds;
the second transient switch command is issued by pressing on a second location of the touch module for N seconds; and
M and N are positive integers.

8. The system of claim 7, wherein:
the first location is different from the second location; and
M is equal to N.

9. The system of claim 7, wherein:
the first location and the second location are at a same location; and
M is different from N.

10. The system of claim 1, wherein:
the first transient switch command is issued by simultaneously generating M touch points within a first range of the touch module;
the second transient switch command is issued by simultaneously generating N touch points within a second range of the touch module; and
M and N are positive integers.

11. The system of claim 10, wherein:
the first range is different from the second range; and
M is equal to N.

12. The system of claim 10, wherein:
the first range is identical to the second range; and
M is different from N.

13. The system of claim 1, wherein:
the first transient switch command is issued by generating a first touch track within a first range of the touch module; and
the second transient switch command is issued by generating a second touch track within a second range of the touch module.

14. The system of claim 13, wherein:
the first range is different from the second range; and
the first touch track is identical to the second touch track.

15. The system of claim 13, wherein:
the first range is identical to the second range; and
the first touch track is different from the second touch track.

16. An electronic device of transiently switching operational modes, comprising:
a touch module configured to operate in a normal mode and at least one transient mode, and output at least one first transient switch signal when receiving a first transient switch command from a user;
a control device electrically connected to the touch module and configured to:
switch the touch module from the normal mode to the at least one transient mode when detecting the at least one first transient switch signal so that the touch module operates in the at least one transient mode during a predetermined period; and
switch the touch module from the at least one transient mode to the normal mode when detecting a second transient switch command after detecting the at least one first transient switch signal or when the predetermined period has elapsed after detecting the at least one first transient switch signal; and
a physical keyboard arranged to generate the second transient switch command or the second transient switch command.
